(19) United States
(12) Patent Application Publication
(10) Pub. No.: US 2020/0336212 A1
(43) Pub. Date: Oct. 22, 2020

(54) REDUCING PATTERN EFFECTS FOR PULSE AMPLITUDE MODULATION SIGNALS IN SEMICONDUCTOR OPTICAL AMPLIFIERS

(71) Applicant: ZTE Corporation, Shenzhen (CN)

(72) Inventors: Jianjun Yu, Basking Ridge, NJ (US); Hung-Chang Chien, Bridgewater, NJ (US)

(21) Appl. No.: 16/391,288

(22) Filed: Apr. 22, 2019

(51) Int. Cl. H04B 10/54; H04L 25/49; H04B 10/564; H04B 10/58; H04B 10/516; H04L 27/26; H04J 14/02

(52) U.S. Cl. CPC H04B 10/541; H04L 25/4917; H04B 10/564; H04J 14/0298; H04B 10/5161; H04L 27/2626; H04B 10/58

(57) ABSTRACT

Methods, systems and devices for reducing pattern effects in pulse amplitude modulation (PAM) signals in semiconductor optical amplifiers (SOAs) are described. One method for digital communication includes generating, based on (2M+1) N-level PAM (PAM-N) symbols, an index corresponding to an entry of a look-up table (LUT) that comprises adjustment values, wherein M and N are integers, determining, based on the index, a selected adjustment value from the LUT, generating a pre-distorted PAM-N symbol based on a difference between a center symbol of the (2M+1) PAM-N symbols and the selected adjustment value, and generating, using an SOA, a waveform that includes the pre-distorted PAM-N symbol.

### TECHNICAL FIELD

This document relates to digital communications, and in one aspect, optical communication systems that use pulse amplitude modulation.

### BACKGROUND

There is an ever-growing demand for data communication in application areas such as wireless communication, fiber optic communication and so on. The demand on core and access networks are all growing higher because not only are user devices such as smartphones and computers using more and more bandwidth due to multimedia applications, but also the total number of devices for which data is carried over the whole network is increasing. For profitability and to meet increasing demand, equipment manufacturers and network operators are continually looking for ways to support high-speed and high-capacity communication links.

### SUMMARY

This document relates to methods, systems, and devices for reducing pattern effects for pulse amplitude modulation (PAM) signals in semiconductor optical amplifiers. In some examples, a look-up table is used to mitigate pattern effects that are caused by gain saturation.

In one exemplary aspect, an optical communication method is disclosed. The method includes generating, based on (2M+1) N-level pulse amplitude modulation (PAM-N) symbols, an index corresponding to an entry of a look-up table (LUT) that comprises adjustment values, wherein M and N are integers, determining, based on the index, a selected adjustment value from the LUT, generating a pre-distorted PAM-N symbol based on a difference between a center symbol of the (2M+1) PAM-N symbols and the selected adjustment value, and generating, using a semiconductor optical amplifier, a waveform that includes the pre-distorted PAM-N symbol.

In another exemplary aspect, an optical communication method is disclosed. The method includes generating, based on (2M+1) symbols, an index corresponding to an entry of a look-up table (LUT) that comprises adjustment values, wherein M is a positive integer, determining, based on the index, a selected adjustment value from the LUT, generating a pre-distorted symbol based on a difference between a center symbol of the (2M+1) symbols and the selected adjustment value, and generating, using a semiconductor optical amplifier, a waveform that includes the pre-distorted symbol.

In yet another exemplary aspect, the above-described methods are embodied in the form of processor-executable code and stored in a computer-readable program medium.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWINGS

FIG. 1 is a schematic diagram of a semiconductor optical amplifier (SOA).

FIG. 2 is an exemplary plot of the SOA gain versus output signal power.

FIG. 3 shows an example of gain compression in an SOA, and the patterning effect of gain compression in eye diagrams (or eye patterns).

FIG. 4 shows an example of a look-up table technique to reduce patterns in PAM-N signals, in accordance with embodiments of the disclosed technology.

FIG. 5 shows an example of the optimization of the higher levels in a PAM-4 signal.

FIGS. 6A and 6B show the PAM levels and an eye diagram for a PAM-4 signal with equally spaced levels, respectively.

FIGS. 7A and 7B show the PAM levels and an eye diagram for a PAM-4 signal with pre-distortion (e.g., unequally spaced levels), respectively.

FIG. 8 shows exemplary experimental results that illustrate the bit error rate (BER) improvements based on embodiments of the disclosed technology.

FIG. 9 shows exemplary experimental results that compare different PAM-4 scenarios illustrating the benefits of embodiments of the disclosed technology.

FIGS. 10A and 10B show flowcharts for example methods for optical communication.

FIG. 11 is a block diagram representation of a portion of an optical transmitter or receiver apparatus.

### DETAILED DESCRIPTION

Semiconductor optical amplifiers (SOAs) are optoelectronic devices similar to semiconductor lasers which are specially designed to amplify light. In contrast to semiconductor lasers, SOA amplify light in a single pass and have, therefore, no optical cavity. The nonlinear behavior of the semiconductor material with respect to the light power, is very often used to perform wavelength conversion and switching functionalities.

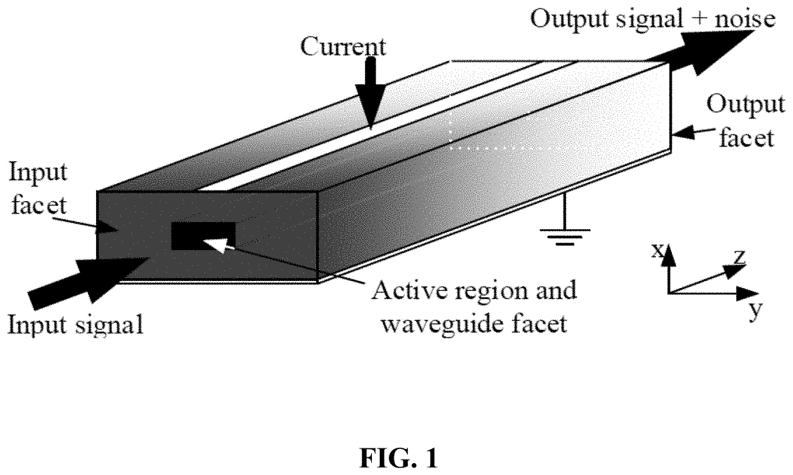

FIG. 1 is a schematic diagram of a semiconductor optical amplifier. As shown therein, an electric current is injected into the active region of the device, realizing the population inversion necessary for the amplification by stimulated emission. The active region is a thin layer between a p-type and a n-type semiconductor layer such that its bandgap is smaller than those of the layers surrounding it. This helps to confine electrons and holes to the middle layer. Only a single waveguide mode exists in the active region of the travelling-wave amplifier.

SOAs amplify incident light using stimulated emission like semiconductor lasers, but without optical feedback. The principle of optical amplification is based on the band structure consisting of a conduction band (CB) and a valence band (VB), both of parabolic form in the energy-wave vector plane.

The optical gain G (also referred to as the amplifier gain or the SOA gain) is defined as the ratio of the output power P^{out} after an SOA with respect to the input power Pᵢₙ being launched into the SOA,

G=P^{out}/Pᵢₙ. (1)

The optical gain value is usually expressed in logarithmic decibel units, G_{dB}=10 log₁₀ G. The gain spectrum of an SOA depends on the material structure and the operating conditions.

Nonlinearities in SOA are caused by an excitation in the gain region, and become noticeable in the gain and in the refractive index of an active material. Both nonlinearities have their origin in the change of carrier density and energy distribution in the CB and the VB.

If the power of the input signal is such that the signal has negligible influence on the SOA gain, the signal is called a “small-signal”. For small input signals with powers which do not saturate the SOA gain, the SOA works as a linear amplifier. As the signal power increases, the carriers in the active region deplete, leading to a decrease in the gain, known as gain saturation effect. The saturation of the amplification is mainly a band filling nonlinearity. It can be regarded as a limitation of the number of states that can participate in transitions giving rise to optical gain.

Based on Equation (1), the output power can be expressed as:

$$\frac{{P}^{o u t}}{{P}_{s a t}} = \frac{ln ( \frac{{G}_{0}}{G} ) G}{G - 1}$$

Herein, Pₛₐₜ is the saturation power of the SOA and G₀ is the unsaturated power gain of the SOA. In the saturation regime, the output power P^{out} is comparable to Pₛₐₜ. However, in the linear regime, wherein G approaches the unsaturated value G₀, the ratio P^{out}/Pₛₐₜ becomes negligible.

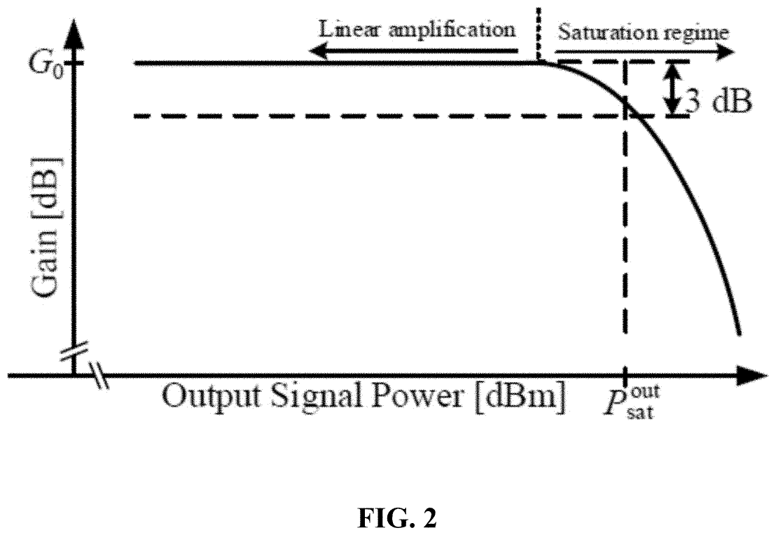

FIG. 2 shows the SOA gain versus the output signal power. The horizontal axis shows output signal power in dBm. The vertical axis shows gain in dB. The term Pₛₐₜ^{out} represents the output power saturation point at which the amplifier gain is suppressed by 3 dB with respect to the unsaturated gain G₀. As can be seen from the graph, for signal powers lower than a nominal power backoff before the saturation point, the gain is relatively constant (flat) as depicted in the linear amplification region. The gain may start dropping at the power backoff point. At the saturation point, the gain may decrease by 3 dB. When the output signal power rises beyond the saturation point, then in saturation regime (region), the gain may reduce with increasing output signal power.

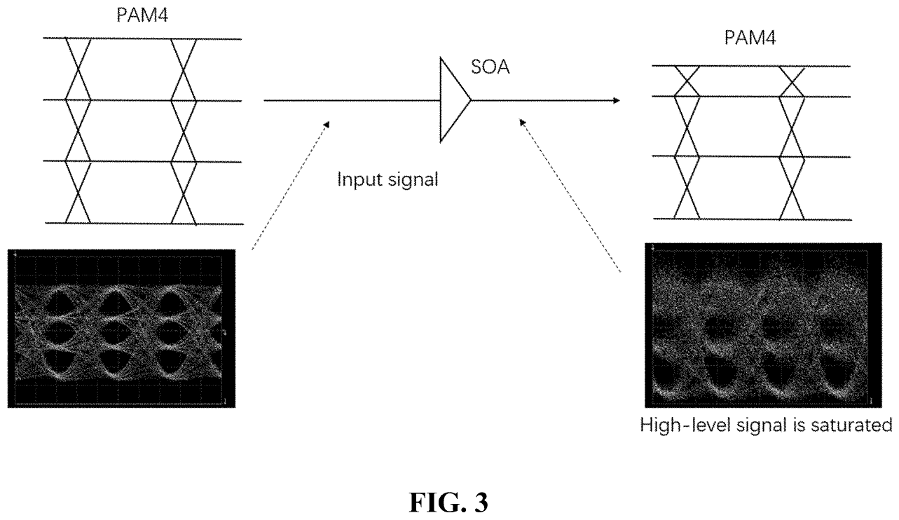

A drawback of SOA-based signal processing systems limiting the maximum usable bit rate is the long carrier recovery time of the SOA device which leads to a significant patterning effect in the signal. FIG. 3 shows an example of gain compression in an SOA, and the patterning effect of gain compression in eye diagrams. As shown therein, and due to the nonlinear gain compression, the higher levels of the PAM4 signal are compressed, leading to a patterning effect that results in closures in higher levels of the eye diagram, and degraded performance (e.g., lower operational data rates, reduced bit error rate (BER)). As depicted in FIG. 3 (right hand side), the output constellation levels of the PAM4 signal are such that for higher symbols, the amplitude difference between neighboring symbols may reduce due to the saturation effect discussed with respect to FIG. 2.

Section headings are used in the present document to improve readability of the description and do not in any way limit the discussion or the embodiments to the respective sections only.

### EXAMPLE EMBODIMENTS OF THE DISCLOSED TECHNOLOGY

Embodiments of the disclosed technology provide, amongst other benefits, two methods to overcome the gain saturation effect in SOAs. In the first method, a look-up table (LUT) technique is used to reduce the patterning effect, whereas in the second method, a pre-distortion technique adjusts the higher levels of the PAM-4 signals.

In some embodiments, the LUT technique is based on a Taylor series model that assumes an ideal input sinusoidal signal, s(t)=s(ωt), and the output of the SOA due to the nonlinearity induced by the gain saturation can be expressed as:

o(t)=A₁s(t)+A₂s²(t)+A₃s³(t)+ . . . .

Herein, A₁, A₂ and A₃ are the first, second and third-order gains of the nonlinear semiconductor optical amplifier, respectively. If it is further assumed that the input signal is a unit-amplitude sinusoidal signal, s(ωt)=cos cot, and A₁>>A₃ based on the operating point of the SOA, the Taylor series model can be expressed as:

$$\begin{matrix}o ( t ) = {A}_{1} cos ω t + {A}_{2} {cos}^{2} ω t + {A}_{3} {cos}^{3} ω t + … \\ = {A}_{1} cos ω t + \frac{{A}_{2}}{2} [ 1 + cos ( 2 ω t ) ] + \frac{{A}_{3}}{4} [ 3 cos ω t + cos ( 3 ω t ) ] + … \\ \approx {A}_{1} cos ω t + \frac{{A}_{2}}{2} cos ( 2 ω t ) + \frac{{A}_{3}}{4} cos ( 3 ω t ) + …\end{matrix}$$

Given the output of the SOA, the error e(t) (also referred to as an adjustment in this document) can be calculated as the difference between a normalized feedback signal, r(t)=o(t)/A₁, and the input sinusoidal signal, and can be expressed as:

$$\begin{matrix}e ( t ) = r ( t ) - s ( t ) \\ = {( cos ω t + \frac{{A}_{2}}{2 {A}_{1}} cos ( 2 ω t ) + \frac{{A}_{3}}{4 {A}_{1}} cos ( 3 ω t ) + \text{...} )}_{- cos ω t} \\ \approx \frac{{A}_{2}}{2 {A}_{1}} cos ( 2 ω t ) + \frac{{A}_{3}}{4 {A}_{1}} cos ( 3 ω t ) + …\end{matrix}$$

In some embodiments, the computed errors can be stored in a look-up table (LUT), and the pre-distorted signal, based on the LUT, can be expressed as

$${s}_{p r e} ( t ) = s ( t ) - e ( t ) \\ = cos ω t - ( \frac{{A}_{2}}{2 {A}_{1}} cos ( 2 ω t ) + \frac{{A}_{3}}{4 {A}_{1}} cos ( 3 ω t ) + \text{...} )$$

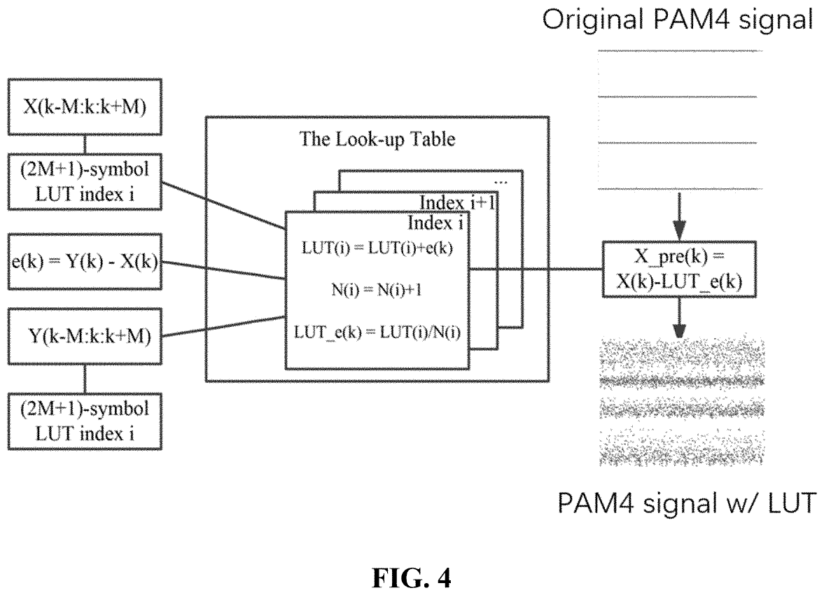

Based on the models described above, FIG. 4 shows an example of a look-up table technique to reduce patterns in PAM-N signals, in accordance with embodiments of the disclosed technology. The LUT stores the errors, which are used to generate the pre-distorted symbols.

In some embodiments, a sequence of symbols X(k−M:k+M) containing 2M+1 PAM-N symbols are used to derive an address for the LUT, e.g., a LUT index that is used to select an error (or adjustment) value from the LUT. This adjustment (or error value) is subtracted from the center symbol of the 2M+1 PAM-N symbols to generate the pre-distorted symbols that can be transmitted using the semiconductor optical amplifier.

Using 2M+1 PAM-N symbols to select an error value (as compared to using a single PAM-N symbol) advantageously takes into account adjacent symbols that can affect the center symbol due to the nonlinearity of the SOA, i.e., since the nonlinearity of the SOA may span multiple symbols (similar to the inter-symbol interference (ISI) effect of a radio frequency (RF) communication channel), compensating for the nonlinearity most effectively requires the use of multiple symbols, thereby incorporating a memory across symbols. If a single symbol were to be used to look up the error value, it would not be able to account for the nonlinearity spanning multiple symbols. Thus, 2M+1 PAM-N symbols are used to index into the LUT to select a single adjustment value, which is used to pre-distort the center PAM-N symbol, and which results in reducing the pattern effect due to the SOA nonlinearity.

In some embodiments, the sequence of symbols X=X(k−M:k+M) may be pilot PAM-N symbols that are known to both the transmitter and receiver. A sliding window of size 2M+1 can be used at the receiver to select symbols from the received symbols Y=Y(k−M:k+M), which can then be converted to a LUT index. The difference between the center symbols of the 2M+1 symbol sequences X and Y corresponds to the error (or adjustment) value for that LUT index. Thus, the receiver can create the LUT using pilot symbols, as shown in FIG. 4.

In some embodiments, the 2M+1 symbols that are used to index into the LUT may be quadrature amplitude modulation (QAM) symbols, carrierless amplitude phase modulation (CAP) symbols, or orthogonal frequency division multiplexing (OFDM) symbols.

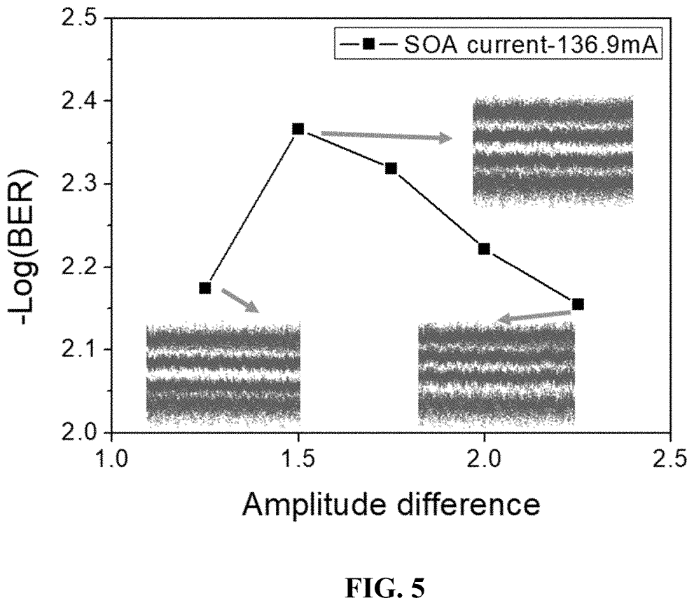

In addition to reducing the patterning effect by pre-distorting the transmitted symbols based on an error selected using multiple PAM-N symbols, embodiments of the disclosed technology can optimize the PAM-N signal levels to further reduce the patterning effect. FIG. 5 shows an example of the optimization of the higher levels in a PAM-4 signal, with −log(BER) plotted as a function of the amplitude difference between the higher PAM-4 signal levels.

The simulation is based on an SOA current of 136.9 mA, an input optical power of −2.8 dBm and a baud rate of 8G. As shown in FIG. 5, the lowest BER is achieved for an amplitude difference of 1.5, and the corresponding plots of the PAM-4 signal levels show a better separation between the levels than, for example, when the amplitude difference is 2.0.

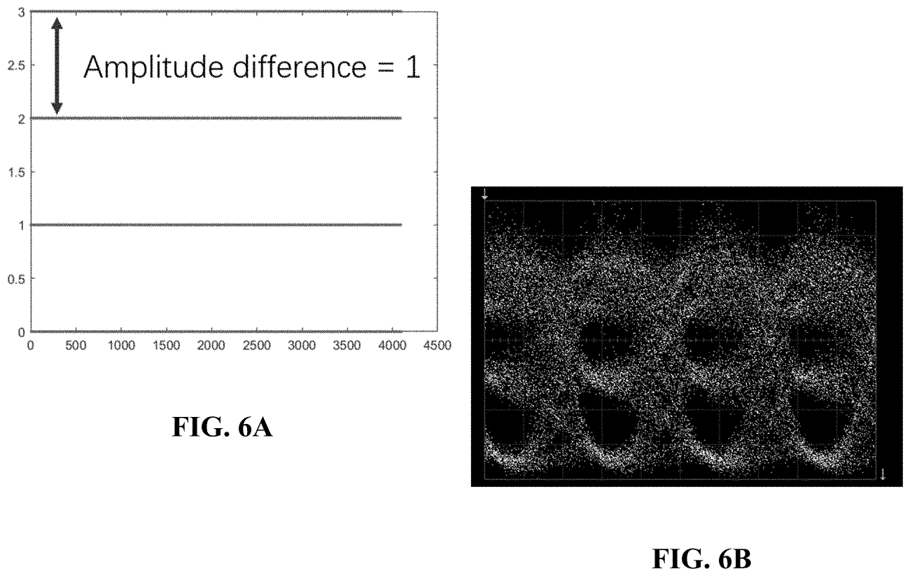

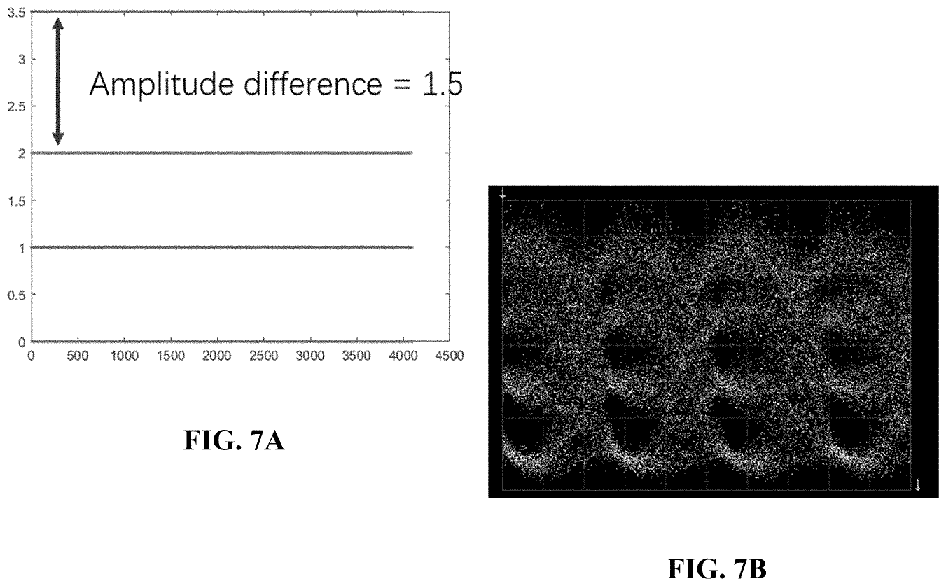

FIGS. 6A and 6B show the PAM levels and an eye diagram for a PAM-4 signal with equally spaced levels, respectively, and FIGS. 7A and 7B show the PAM levels and an eye diagram for a PAM-4 signal unequally spaced levels, respectively. A comparison of FIGS. 6B and 7B shows that the opening of the eye diagram is better when the amplitude difference between the higher levels of the PAM-4 signal constellation is 1.5.

Embodiments of the disclosed technology may be configured to use either the look-up table (LUT) or the optimized PAM-N levels, or a combination of both, in order to reduce the patterning effect for PAM-N signal in a semiconductor optical amplifier.

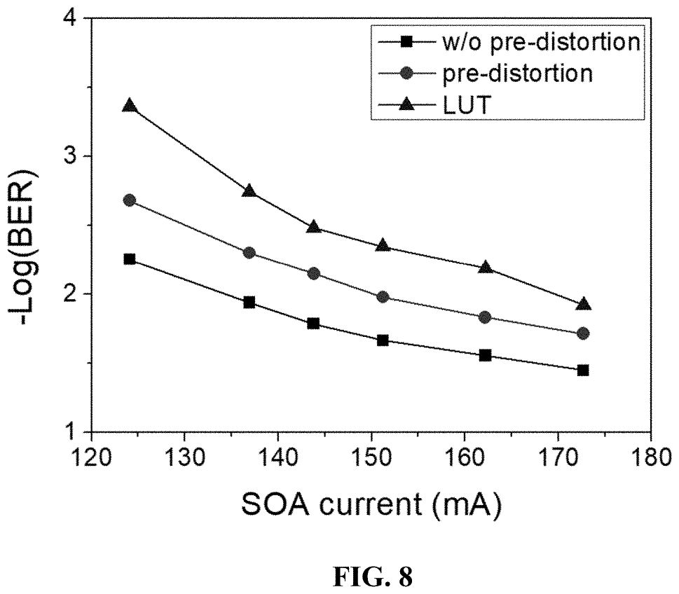

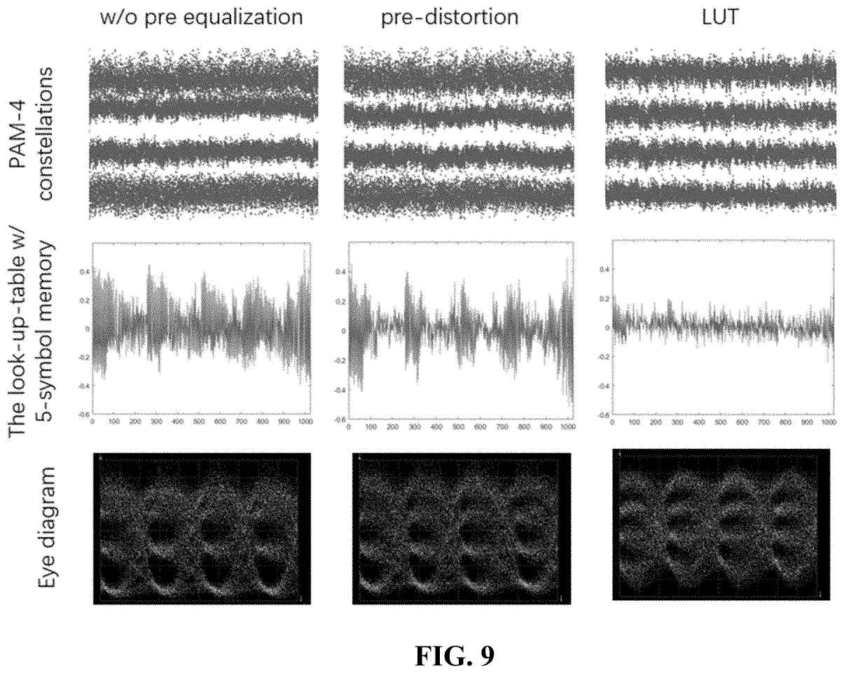

FIG. 8 shows exemplary experimental results that illustrate the bit error rate (BER) improvements based on embodiments of the disclosed technology. Specifically, FIG. 8 plots −log(BER) as a function of the SOA current (in milli-Amperes), and as seen therein, a system using the LUT outperforms systems that use only the optimized PAM4 levels and systems without any pre-distortion over a large range of SOA current values. The comparison between these systems is further elucidated in FIG. 9, which shows the PAM-4 constellations, the LUT with a 5-symbol memory (i.e., M=2) and the eye diagrams for each of the systems.

Example Methods for Reducing Pattern Effects of PAM Signals in SOAs

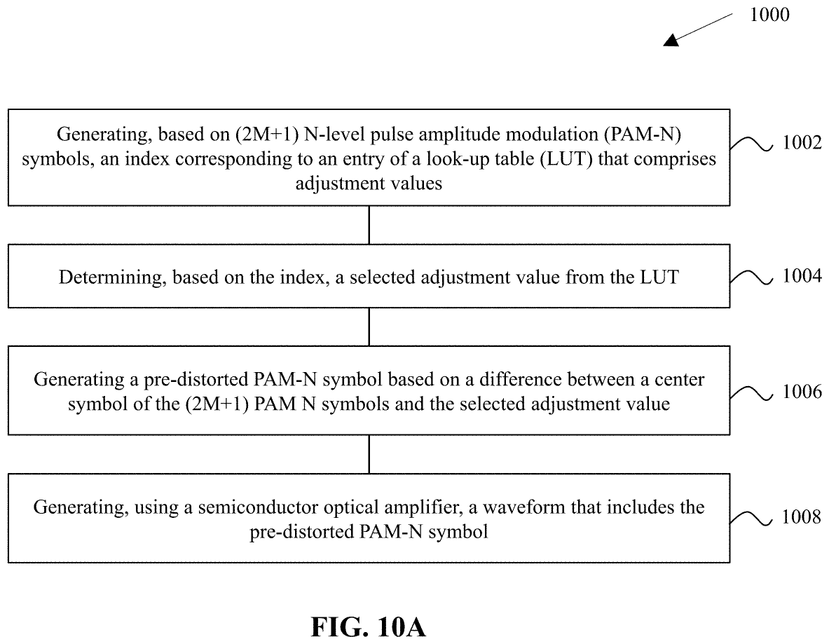

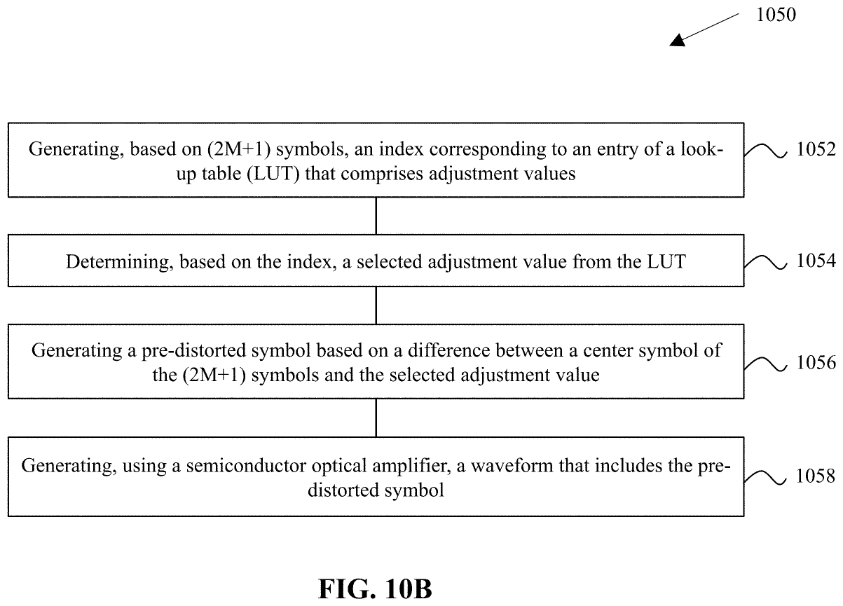

FIG. 10A shows a flowchart of an example method 1000 for optical communication. The method 1000 includes, at step 1002, generating, based on (2M+1) N-level pulse amplitude modulation (PAM-N) symbols, an index corresponding to an entry of a look-up table (LUT) that comprises adjustment values, wherein M and N are positive integers.

The method 1000 includes, at step 1004, determining, based on the index, a selected adjustment value from the LUT.

The method 1000 includes, at step 1006, generating a pre-distorted PAM-N symbol based on a difference between a center symbol of the (2M+1) PAM-N symbols and the selected adjustment value.

The method 1000 includes, at step 1008, generating, using a semiconductor optical amplifier, a waveform that includes the pre-distorted PAM-N symbol. In some embodiments, the semiconductor optical amplifier (SOA) is operating in a saturation region that is characterized by an output power level of the SOA being less than an input power level to the SOA multiplied by a linear gain of the SOA.

In some embodiments, N=4 and M=2.

In some embodiments, the adjustment values in the LUT are based on a Taylor series model of an output o(t) of the semiconductor optical amplifier that includes at least o(t)=A₁ s(t)+A₂ s² (t)+A₃ s³ (t), s(t) is an ideal sinusoidal input and A₁, A₂ and A₃ are first-order, second-order and third-order gains associated with one or more non-linearities of the semiconductor optical amplifier, respectively. In an example, the semiconductor optical amplifier is used at an operating point where A₁ is at least twice as large as A₃. In another example, A₁ is one or more orders of magnitude larger than A₃. More generally, A₁>>A₃.

In some embodiments, the method 1000 further includes the step of selecting the (2M+1) PAM-N symbols from a PAM constellation with unequal spacings between levels of the PAM constellation. In an example, a first spacing between higher levels of the PAM constellation is greater than a second spacing between other levels of the PAM constellation. For example, and as shown in FIGS. 6A and 7A, N=4, the first spacing is 1.5, and the second spacing is 1.0.

FIG. 10B shows a flowchart of an example method 1050 for optical communication. The method 1050 includes, at step 1052, generating, based on (2M+1) symbols, an index corresponding to an entry of a look-up table (LUT) that comprises adjustment values, wherein M is a positive integer.

The method 1050 includes, at step 1054, determining, based on the index, a selected adjustment value from the LUT.

The method 1050 includes, at step 1056, generating a pre-distorted symbol based on a difference between a center symbol of the (2M+1) symbols and the selected adjustment value.

The method 1050 includes, at step 1058, generating, using a semiconductor optical amplifier, a waveform that includes the pre-distorted symbol. In some embodiments, the semiconductor optical amplifier (SOA) is operating in a saturation region that is characterized by an output power level of the SOA being less than an input power level to the SOA multiplied by a linear gain of the SOA.

In some embodiments, the (2M+1) symbols comprise N-level pulse amplitude modulation (PAM-N) symbols.

In some embodiments, the (2M+1) symbols comprise quadrature amplitude modulation (QAM) symbols, carrierless amplitude phase modulation (CAP) symbols or orthogonal frequency division multiplexing (OFDM) symbols.

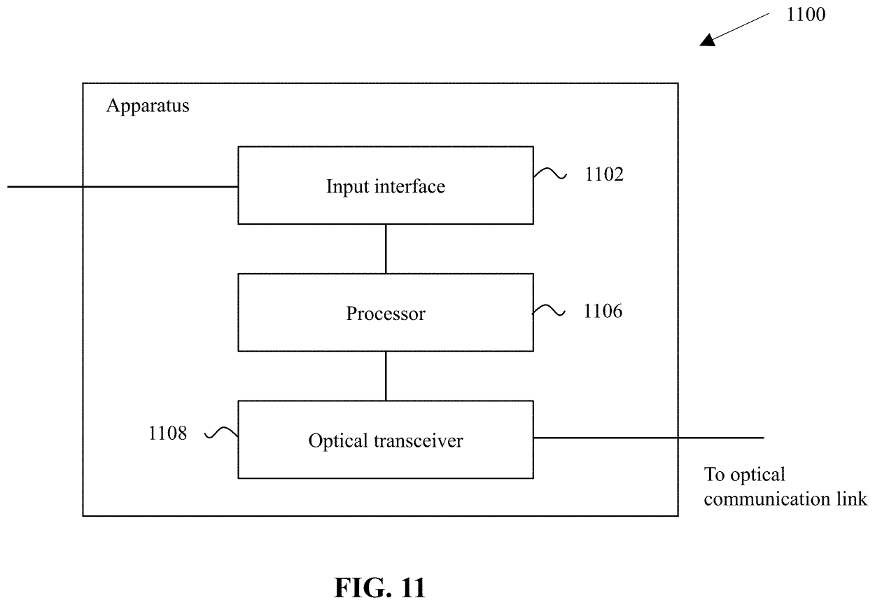

FIG. 11 shows an example of an optical transmitter or receiver apparatus 1100 where the techniques described herein may be performed. The apparatus 1100 may be include an input interface 1102 at which user data may be received for transmission over an optical communication link. The apparatus may include a processor 1106 that is configured to perform the various techniques described in the present document. The apparatus 1100 may also include an optical transceiver 1108 that includes a transmitter circuit and a receiver circuit that performs various operations, including method 1000, described herein.

It is intended that the specification, together with the drawings, be considered exemplary only, where exemplary means an example and, unless otherwise stated, does not imply an ideal or a preferred embodiment. As used herein, “or” is intended to include “and/or”, unless the context clearly indicates otherwise.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A method optical communication, comprising:
generating, based on (2M+1) N-level pulse amplitude modulation (PAM-N) symbols, an index corresponding to an entry of a look-up table (LUT) that comprises adjustment values;
determining, based on the index, a selected adjustment value from the LUT;
generating a pre-distorted PAM-N symbol based on a difference between a center symbol of the (2M+1) PAM-N symbols and the selected adjustment value; and
generating, using a semiconductor optical amplifier, a waveform that includes the pre-distorted PAM-N symbol,
wherein M and N are positive integers.

2. The method of claim 1, wherein the semiconductor optical amplifier (SOA) is operating in a saturation region that is characterized by an output power level of the SOA being less than an input power level to the SOA multiplied by a linear gain of the SOA.

3. The method of claim 1, wherein N=4 and M=2.

4. The method of claim 1, wherein the adjustment values in the LUT are based on a Taylor series model of an output o(t) of the semiconductor optical amplifier that includes at least
o(t)=A₁s(t)+A₂s²(t)+A₃s³(t),
wherein s(t) is an ideal sinusoidal input and A₁, A₂ and A₃ are first-order, second-order and third-order gains associated with one or more non-linearities of the semiconductor optical amplifier, respectively.

5. The method of claim 4, wherein the semiconductor optical amplifier is used at an operating point where A₁ is at least twice as large as A₃.

6. The method of claim 1, further comprising:
selecting the (2M+1) PAM-N symbols from a PAM constellation with unequal spacings between levels of the PAM constellation.

7. The method of claim 6, wherein a first spacing between higher levels of the PAM constellation is greater than a second spacing between other levels of the PAM constellation.

8. The method of claim 7, wherein N=4, wherein the first spacing is 1.5, and wherein the second spacing is 1.0.

9. An apparatus for optical communication, comprising:
a processor configured to
generate, based on (2M+1) N-level pulse amplitude modulation (PAM-N) symbols, an index corresponding to an entry of a look-up table (LUT) that comprises adjustment values, wherein M and N are positive integers,
determine, based on the index, a selected adjustment value from the LUT, and
generate a pre-distorted PAM-N symbol based on a difference between a center symbol of the (2M+1) PAM-N symbols and the selected adjustment value; and
a semiconductor optical amplifier, coupled to the process, configured to generate a waveform that includes the pre-distorted PAM-N symbol.

10. The apparatus of claim 9, wherein the semiconductor optical amplifier (SOA) is operating in a saturation region that is characterized by an output power level of the SOA being less than an input power level to the SOA multiplied by a linear gain of the SOA.

11. The apparatus of claim 9, wherein N=4 and M=2.

12. The apparatus of claim 9, wherein the adjustment values in the LUT are based on a Taylor series model of an output o(t) of the semiconductor optical amplifier that includes at least
o(t)=A₁s(t)+A₂s²(t)+A₃s³(t),
wherein s(t) is an ideal sinusoidal input and A₁, A₂ and A₃ are first-order, second-order and third-order gains associated with one or more non-linearities of the semiconductor optical amplifier, respectively.

13. The apparatus of claim 12, wherein the semiconductor optical amplifier is used at an operating point where A₁ is at least twice as large as A₃.

14. The apparatus of claim 9, wherein the processor is further configured to
select the (2M+1) PAM-N symbols from a PAM constellation with unequal spacings between levels of the PAM constellation.

15. The apparatus of claim 14, wherein a first spacing between higher levels of the PAM constellation is greater than a second spacing between other levels of the PAM constellation.

16. The apparatus of claim 15, wherein N=4, wherein the first spacing is 1.5, and wherein the second spacing is 1.0.

17. A non-transitory computer readable program storage medium having code stored thereon, the code, when executed by a processor, causing the processor to implement a method for optical communication, the method comprising:
generating, based on (2M+1) symbols, an index corresponding to an entry of a look-up table (LUT) that comprises adjustment values, wherein M is a positive integer;
determining, based on the index, a selected adjustment value from the LUT;
generating a pre-distorted symbol based on a difference between a center symbol of the (2M+1) symbols and the selected adjustment value; and
generating, using a semiconductor optical amplifier, a waveform that includes the pre-distorted symbol.

18. The non-transitory computer readable program storage medium of claim 17, wherein the semiconductor optical amplifier (SOA) is operating in a saturation region that is characterized by an output power level of the SOA being less than an input power level to the SOA multiplied by a linear gain of the SOA.

19. The non-transitory computer readable program storage medium of claim 17, wherein the (2M+1) symbols comprise N-level pulse amplitude modulation (PAM-N) symbols.

20. The non-transitory computer readable program storage medium of claim 17, wherein the (2M+1) symbols comprise quadrature amplitude modulation (QAM) symbols, carrierless amplitude phase modulation (CAP) symbols or orthogonal frequency division multiplexing (OFDM) symbols.
